(19) United States
(12) Patent Application Publication
(10) Pub. No.: US 2026/0241924 A1
(43) Pub. Date: Aug. 20, 2026

(54) VEHICLE CONTROL DEVICE

(71) Applicant: Astemo, Ltd., Tokyo (JP)

(72) Inventors: Sara SUDA, Hitachinaka-shi, Ibaraki (JP); Satoshi KASHIWAMURA, Hitachinaka-shi, Ibaraki (JP)

(73) Assignee: Astemo, Ltd., Tokyo (JP)

(21) Appl. No.: 19/164,499

(22) PCT Filed: May 22, 2023
(86) PCT No.: PCT/JP2023/018952

§ 371 Date: Sep. 11, 2025

(51) Int. Cl. B60W 30/09; B60W 50/14

(52) U.S. Cl. CPC B60W 30/09; B60W 50/14; B60W 2050/143; B60W 2554/20; B60W 2554/4041; B60W 2554/4042

(57) ABSTRACT

A vehicle control device suppresses unnecessary activation of a collision mitigation system due to reduced accuracy during turning of a host vehicle. The device comprises a rotational speed acquisition unit configured to obtain the vehicle's rotational speed, and a vehicle speed acquisition unit configured to obtain the host vehicle's speed. A target position acquisition unit obtains the position of a target recognized by an external environment recognition unit, while a target ground speed calculation unit determines the ground speed of the recognized target. A reference target ground speed error calculation unit derives ground speed error of a reference target. Based on this error, a driving assistance function calculation unit determines the execution content of a driving assistance function related to vehicle safety with respect to a recognized moving object. An output unit transmits control instructions to driving assistance execution units according to the determined execution content.

### TECHNICAL FIELD

The present invention relates to a vehicle control device.

### BACKGROUND ART

In applications of a vehicle control device of an automobile, a collision mitigation system has become widely used, which detects an obstacle ahead, using an external environment recognition sensor composed of a camera, a millimeter wave radar, or the like incorporated in the vehicle, and, when the risk of collision arises, automatically applies a brake to avoid a collision and reduce collision damage.

In recent years, the application range of the collision mitigation system has been expanded so that the system is activated not only in a case where a collision is avoided when a host vehicle is traveling straight ahead but also in a case where the host vehicle makes a turn at an intersection or the like.

Activating the collision mitigation system correctly requires that such information as the position and the speed of a target around the host vehicle be grasped correctly. When speed information on a target around the host vehicle is grasped, using an external environment recognition sensor incorporated in the vehicle, a change in a relative position with respect to the target that results from movement or rotation of the host vehicle and a change in a relative position that results from movement of the target itself are detected collectively in their composite form.

However, the movement of the host vehicle and the movement of the target are different in characteristics and therefore error characteristics developing in both movements are different, too. It is therefore desirable that, to activate the collision mitigation system correctly, the error characteristics be separated from each other and treated separately.

To separate ground speed information on the target from information obtained from the external environment recognition sensor, at least a peripheral speed component resulting from the rotational motion of the host vehicle needs to be removed. A yaw rate sensor is generally used to obtain information on the rotational motion of the host vehicle. However, because of its detection principle different from that of the external environment recognition sensor, the yaw rate sensor is prone to have its detection phase shifted. For this reason, in an environment where the rotating speed of the host vehicle is likely to change, such as a scene where the host vehicle is steered in one direction and the opposite direction in an S-curve road or an intersection, an error in the ground speed of the target tends to arise.

In a situation where the host vehicle is making a turn, which is different from a situation where the host vehicle is traveling straight ahead, the speed accuracy of the target tends to drop, and this drop in the speed accuracy readily leads to undesirable system activation, in which the system is activated unnecessarily to erroneously determine that the host vehicle will collide with a pedestrian, with whom the host vehicle actually will not collide.

Therefore, when the host vehicle is making a turn, the collision mitigation system needs a measure to prevent its unnecessary activation.

PTL 1 describes a method by which a relative speed of a target is subtracted from the sum of a relative speed obtained from a sensor and a host vehicle speed to highly accurately separate a target ground speed when the host vehicle is making a turn.

### CITATION LIST

### Patent Literature

PTL 1: WO 2022/113472

### SUMMARY OF INVENTION

### Technical Problem

According to the technique described in PTL 1, from a detection value of an external environment recognition sensor attached to a given place, a speed component, which results from a deviation between an external environment recognition sensor attachment position and a vehicle rotation center position, is removed to calculate a target ground speed. Reducing sensor errors including a phase shift at each sensor is, therefore, not the object of this technique.

The technique, therefore, does not prevent unnecessary activation of the collision mitigation system caused by a sensor error during the host vehicle's making a turn.

An object of the present invention is to achieve a vehicle control device that can suppress unnecessary activation of a collision mitigation system caused by a drop in detection accuracy of target information when a host vehicle is making a turn.

### Solution to Problem

In order to achieve the above object, the present invention is configured as follows.

A vehicle control device includes: a rotating speed acquisition unit that acquires a rotating speed of a vehicle; a vehicle speed acquisition unit that acquires a speed of the vehicle; a target position acquisition unit that acquires a position of a target recognized by an external environment recognition unit incorporated in the vehicle; a target ground speed calculation unit that acquires a ground speed of the target recognized by the external environment recognition unit; a reference target ground speed error calculation unit that acquires a ground speed error of a reference target serving as a reference outside the vehicle; a driving assistance function calculation unit that obtains the execution content of a driving assistance function related to safety of the vehicle against a moving object recognized by the external environment recognition unit, using the ground speed error of the reference target; and an output unit that outputs a control instruction for executing the driving assistance function, to a driving assistance function execution unit of the vehicle, based on the execution content obtained by the driving assistance function calculation unit.

### Advantageous Effects of Invention

According to the present invention, the vehicle control device that can suppress unnecessary activation of the collision mitigation system caused by a drop in detection accuracy of target information when the host vehicle is making a turn can be provided.

Problems, configurations of the present invention, and effects other than those described above will be made clear by the following description of embodiments.

### BRIEF DESCRIPTION OF DRAWINGS

FIG. 1 is a configuration explanatory diagram showing a configuration example of a vehicle control device according to a first embodiment of the present invention.

FIG. 2 is an explanatory diagram of a vehicle coordinate system according to the first embodiment of the present invention and is an explanatory diagram of the content of calculations carried out by a target ground speed calculation unit.

FIG. 3 is a flowchart showing a process flow of a reference target ground speed error calculation unit according to the first embodiment of the present invention.

FIG. 4 is a flowchart showing a process flow of a driving assistance function calculation unit according to the first embodiment of the present invention.

FIG. 5A depicts an example of a correction map of a gain for alarming according to the first embodiment of the present invention.

FIG. 5B depicts an example of a correction map of a gain for collision avoidance braking according to the first embodiment of the present invention.

FIG. 6A is a bird's-eye view of an example of an assumed scene for explaining the first embodiment of the present invention.

FIG. 6B is a bird's-eye view of an example of an assumed scene for explaining the first embodiment of the present invention.

FIG. 7 is a configuration explanatory diagram showing a configuration example of a vehicle control device according to a second embodiment of the present invention.

FIG. 8 is an explanatory diagram of a GPS coordinate system according to a second embodiment of the present invention.

FIG. 9 is a flowchart showing a process flow of a reference target ground speed error calculation unit according to the second embodiment of the present invention.

FIG. 10 is a bird's-eye view of an example of an assumed scene for explaining the second embodiment of the present invention.

FIG. 11 is a configuration explanatory diagram showing a configuration example of a vehicle control device according to a third embodiment of the present invention.

FIG. 12 is a flowchart showing a process flow of a reference target ground speed error calculation unit 3 according to the third embodiment of the present invention.

FIG. 13 is a bird's-eye view of an example of an assumed scene for explaining the third embodiment of the present invention.

FIG. 14 is a configuration explanatory diagram showing a configuration example of a vehicle control device according to a fourth embodiment of the present invention.

FIG. 15 is a flowchart showing a process flow of a reference target ground speed error calculation unit 4 according to the fourth embodiment of the present invention

FIG. 16 is a bird's-eye view of an example of an assumed scene for explaining the fourth embodiment of the present invention.

### DESCRIPTION OF EMBODIMENTS

Embodiments of the present invention will hereinafter be described with reference to the drawings.

A vehicle control device of the present invention is a vehicle control device that detects a target around a vehicle and that controls the vehicle. When a camera, which is an external environment recognition sensor, detects an object matching a shape learned in advance as a stationary object, the vehicle control device, which utilizes a fact that the true value of a ground speed of a stationary object is zero, determines that ground speed detection accuracy has dropped due to some factor, such as a sensor error, in a case where the ground speed of the stationary object calculated by the external environment recognition sensor is large, and adjusts timing to execute collision avoidance control, such as automatic brake control of automatically applying a braking force to the vehicle or alarming.

In the present invention, when the external environment recognition sensor has been able to simultaneously detect targets as control subjects, e.g., a pedestrian and a stationary object, such as a road sign, ground speed information on the stationary object is calculated, the detection accuracy of the external environment recognition sensor is evaluated according to the magnitude of the ground speed of the stationary object, and when the detection accuracy is low, correction, such as delaying activation of a collision mitigation system, is made to suppress unnecessary activation of the collision mitigation system.

The collision mitigation system refers to, for example, sounding an alarm, executing automatic braking, turning a lamp on, and automatic steering.

### EMBODIMENTS

### First Embodiment

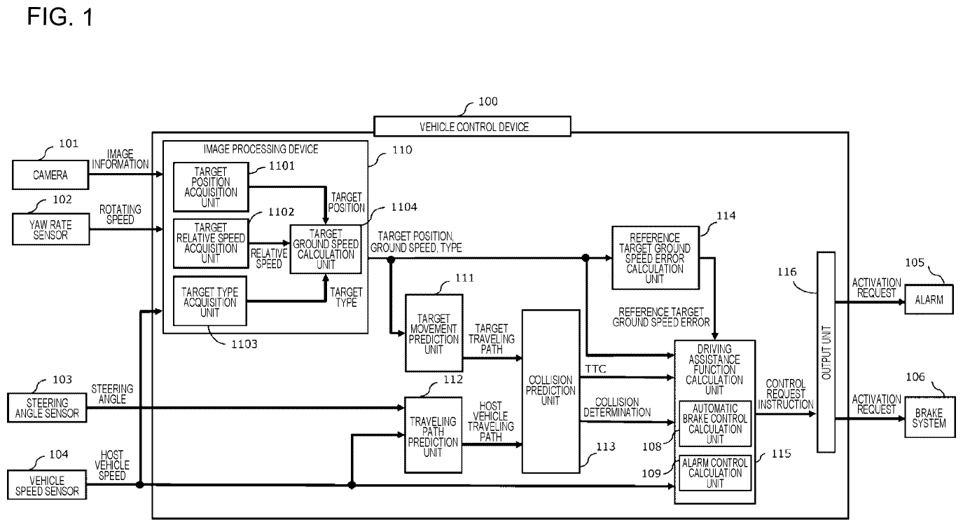

A first embodiment of the present invention will first be described with reference to FIGS. 1 to 6.

FIG. 1 is a configuration explanatory diagram showing an example of a configuration of a vehicle control device 100 according to the first embodiment of the present invention. The vehicle control device 100 is a device for executing the collision mitigation system that detects a target around a host vehicle and that controls the host vehicle.

In FIG. 1, the vehicle control device 100 includes an image processing unit 110. The image processing unit 110 includes: a target position acquisition unit 1101 that calculates position information on a target, from image information acquired from a camera (external environment recognition unit) 101, which is an external environment recognition sensor, rotating speed information on the host vehicle that is obtained from a yaw rate sensor (rotating speed acquisition unit that acquires a rotating speed of the vehicle) 102, and host vehicle speed information acquired from a vehicle speed sensor (vehicle speed acquisition unit) 104; a target relative speed acquisition unit 1102 that calculates a target speed; and a target type acquisition unit 1103 that determines a type of a target, and further includes a target ground speed calculation unit 1104 that calculates a ground speed of a target from results given by these units.

The vehicle control device 100 includes: a target movement prediction unit 111 that predicts a future target movement trajectory, using a target position, a ground speed, and a type that are calculated by the image processing unit 110; a traveling path prediction unit 112 that predicts a future traveling trajectory of the host vehicle, using steering angle information acquired from a steering angle sensor 103 and a host vehicle speed acquired from the vehicle speed sensor (vehicle speed acquisition unit that acquires the speed of the vehicle) 104; and a collision prediction unit 113 that determines whether a collision occurs, based on information on a target traveling path given by the target movement prediction unit 111 and on information on a host vehicle traveling path given by the traveling path prediction unit 112, and that, when determining that the collision occurs, calculates a time to collision (which will hereinafter be abbreviated as TTC).

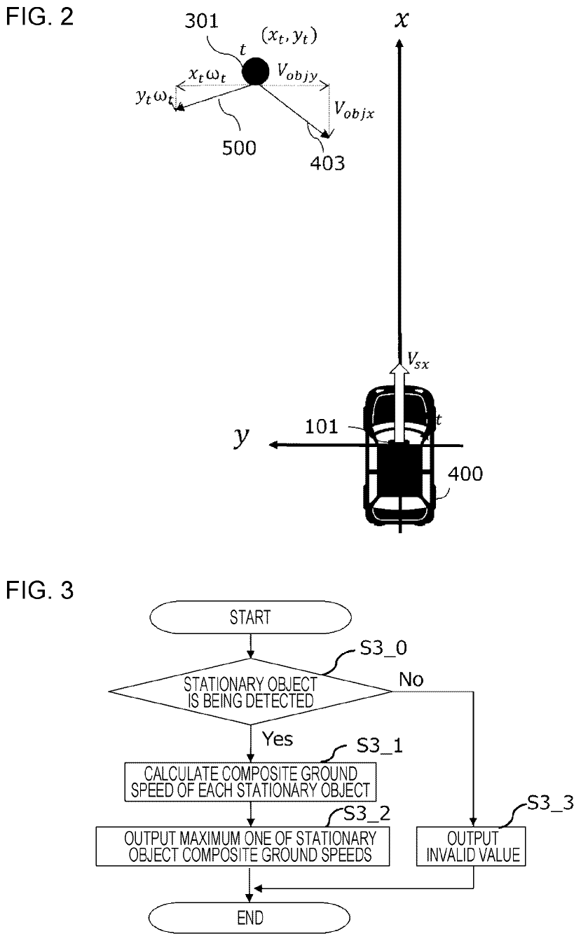

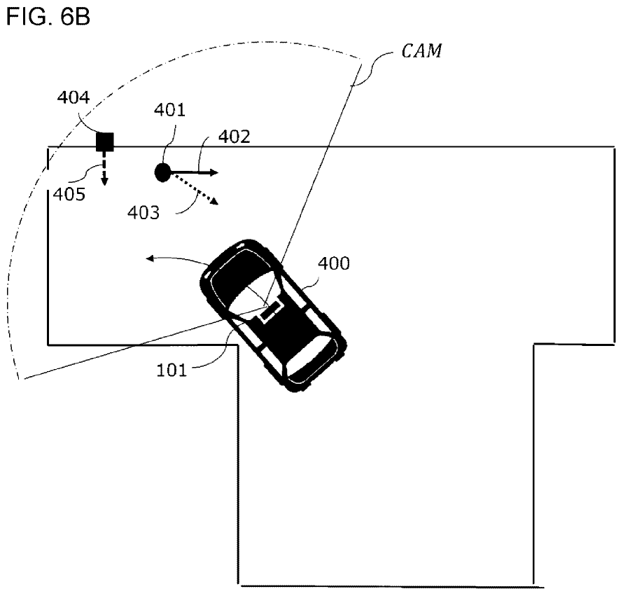

The vehicle control device 100 further includes a reference target ground speed error calculation unit 114 that when the image processing unit 110 is detecting a reference target with a ground speed of which the true value can be grasped, calculates a ground speed error in the front-to-rear direction and that in the left-to-right direction of the reference target. The reference target ground speed error calculation unit 114 acquires a ground speed error of a reference target 404 (shown in FIG. 6A), which serves as a reference outside a vehicle 400 (shown in FIG. 2).

In the first embodiment, a stationary object that does not move, such as a road sign, is used as a reference target. The vehicle control device 100 includes a driving assistance function calculation unit 115 that determines whether or not to make a collision mitigation control request using a reference target ground speed error, a time to collision TTC, a collision determination, and a host vehicle speed. The driving assistance function calculation unit 115 obtains the execution content of a driving assistance function related to the safety of the vehicle 400 against a moving object recognized by the camera 101, using a ground speed error of the reference target 404.

The vehicle control device 100 is a mechanism in which a control request instruction calculated by the driving assistance function calculation unit 115 is received by the output unit 116 and is transmitted to an alarm 105 and a brake system 106. The alarm 105 and the brake system 106 serve as driving assistance function execution units.

Based on the execution content obtained by the driving assistance function calculation unit 115, the output unit 116 outputs a control instruction for executing the driving assistance function, to the driving assistance function execution units 105 and 106 of the vehicle 400.

The driving assistance calculation unit 115 includes an automatic brake control calculation unit 108 and an alarm control calculation unit 109.

With respect to a moving object recognized by the camera 101, the automatic brake control calculation unit 108 obtains the execution content of automatic brake control of automatically applying a braking force to the vehicle 400, the automatic brake control being one of the driving assistance functions related to the safety of the vehicle 400, based on a ground speed error of the reference target 114.

Based on a result from the automatic brake control calculation unit 108, the output unit 116 outputs a control instruction for executing the automatic brake control, to a brake actuator in the brake system of the vehicle 400.

With respect to a moving object recognized by the camera 101, the alarm control calculation unit 109 obtains the execution content of alarm control for issuing an alarm to the driver of the vehicle 400, the alarm control being one of the driving assistance functions related to the safety of the vehicle 400, based on a ground speed error of the reference target 114.

Based on a result from the alarm control calculation unit 109, the output unit 116 outputs a control instruction for executing the alarm control, to the alarm 15 of the vehicle 400.

In the first embodiment of the present invention, the brake system 106 and the alarm 105 have been described as examples of safety devices to which instruction are outputted. However, safety devices to which instruction are outputted are not limited to these devices. For example, the present invention includes an application in which an instruction is outputted to a driving assistance function that assists the driver in steering to avoid a collision.

FIG. 2 is an explanatory diagram of a vehicle coordinate system according to the first embodiment and is an explanatory diagram of the content of calculations carried out by the target ground speed calculation unit 1104.

In the first embodiment, as illustrated in FIG. 2, a geometric relationship with each target, the geometric relationship being obtained by the camera 101 that is the external environment recognition sensor incorporated in the host vehicle 400, is described in a coordinate system in which the vehicle's center of gravity is defined as an origin, the front-to-rear direction of the vehicle is defined as an X-axis with its forward direction being plus, the left-to-right direction of the vehicle is defined as a Y-axis with its left direction being plus, and the forward direction of the vehicle is defined as zero degree, with counterclockwise rotation defined as a plus angle. This coordinate system will hereinafter be referred to as a vehicle coordinate system.

The camera 101, which is the external environment recognition sensor incorporated in the host vehicle 400, may be a monocular camera or a compound-eye camera, and may be provided as a single camera or a plurality of cameras. If the camera 101 functions as a sensor that detects a feature of an object, such as its shape, and that allows matching with a reference target preregistered in the vehicle control device 100, such a sensor is not necessarily provided as a camera.

When the camera 101 recognizes a target 301, the target position acquisition unit 1101 acquires a position (x_{obj}, y_{obj}) of the target 301 in the vehicle coordinate system.

A target relative speed [m/sec] representing a change in the position (x_{obj}, y_{obj}) of the target 301 in a given time Δt [sec] is acquired by the target relative speed acquisition unit 1102, using equation (1) below. It should be noted that (x_{obj_z}, y_{obj_z}) denotes a position of the target 301 at the point given time Δt [sec] before the present time

$$\begin{matrix}[ Equation 1 ] & \\ ( \frac{{x}_{obj} - {x}_{obj\_z}}{Δ t} , \frac{{y}_{obj} - {y}_{obj\_z}}{Δ t} ) & ( 1 )\end{matrix}$$

When a rotating speed of the host vehicle 400 is denoted as ωt [rad/sec], a relative peripheral speed 500 of a pedestrian is given by equation (2) below. It follows from this that when a moving speed of the host vehicle 400 in the x-axis and the same in the y-axis directions are denoted as (Vₛₓ, V_{sy}) [m/sec], a ground speed 403 (V_{objx}, V_{objy}) [m/sec] of the pedestrian is given by equation (3) below. This calculation is carried out by the target ground speed calculation unit 1104. This example is an example of a low vehicle speed region where the host vehicle 400 is making a turn at an intersection. For this reason, the speed Vₛₓ [m/sec] in the x-axis direction of the host vehicle 400 may be considered to be a speed matching a host vehicle speed obtained from the vehicle speed sensor 104, and the speed V_{sy}[m/sec] in the y-axis direction of the host vehicle 400 may be considered to be substantially zero.

Equation (3) below is an equation formulated on the assumption that the camera 101 is mounted at the rotation center of the host vehicle 400. Depending on the mounting position of the camera 101, therefore, a camera peripheral speed needs to be added, with the distance between the camera 101 and the rotation center of the vehicle 400 taken into consideration.

$$\begin{matrix}[ Equation 2 ] & \\ ( - {y}_{obj} {ω}_{t} , {x}_{obj} {ω}_{t} ) & ( 2 )\end{matrix}$$

$$\begin{matrix}[ Equation 3 ] & \\ ( {V}_{objx} , {V}_{objy} ) = ( \frac{{x}_{obj} - {x}_{obj\_z}}{Δ t} + {V}_{sx} - {y}_{obj} {ω}_{t} , \frac{{x}_{obj} - {x}_{obj\_z}}{Δ t} + {V}_{sy} - {x}_{obj} {ω}_{t} ) & ( 3 )\end{matrix}$$

In the first embodiment, for example, a stationary object fixed on the road and known to be unmovable, such as a road sign, a utility pole, or a post, is defined as a reference target.

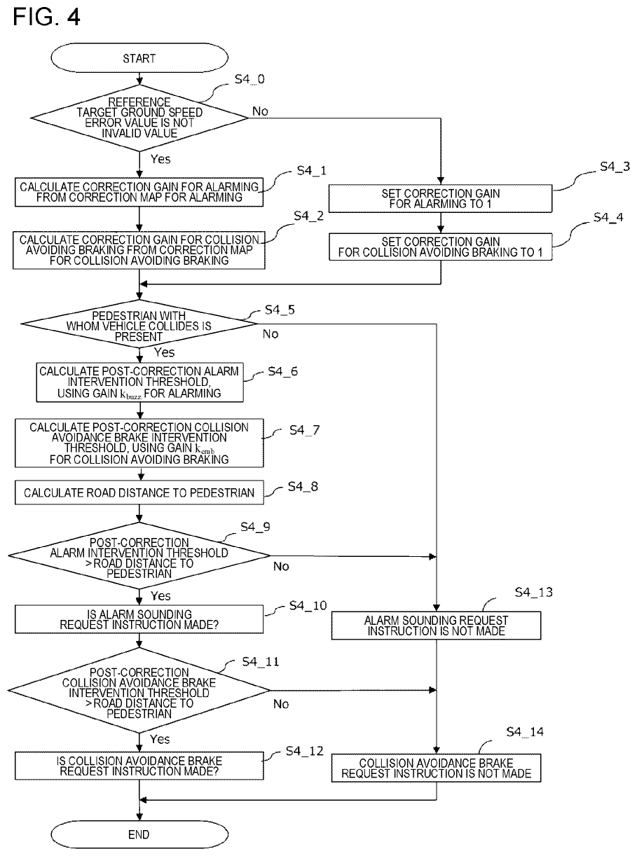

FIG. 3 shows a process flow of a program executed by the reference target ground speed error calculation unit 114, with a stationary object defined as a reference target. In this process flow, the image processing unit 110 determines a detection object to be a stationary object, based on its feature, such as a shape.

It is determined at step S3_0 whether at least one or more stationary objects are being detected among detection objects. When the stationary object is being detected (Yes), with respect to ground speed information on the stationary object outputted from the image processing unit 110, a composite speed V_{obj} [m/sec] is calculated at S3_1 by equation (4) below, using a ground speed (V_{objx}, V_{objy}) [m/sec] of the stationary object.

Because the true value of the composite speed V_{obj} [m/sec] is zero, the composite speed V_{obj} [m/sec] can be treated as a ground speed error. At step S3_2, when a plurality of stationary objects are being detected simultaneously, the maximum one of composite speeds V_{obj} of the stationary objects is selected and is outputted as a reference target ground speed error, to the driving assistance function calculation unit 115.

If no stationary object is detected at step S3_0, the reference target ground speed error is outputted as an invalid value at S3_3.

$$\begin{matrix}[ Equation 4 ] & \\ {V}_{obj} = \sqrt{{V}_{objx}^{2} + {V}_{objy}^{2}} & ( 4 )\end{matrix}$$

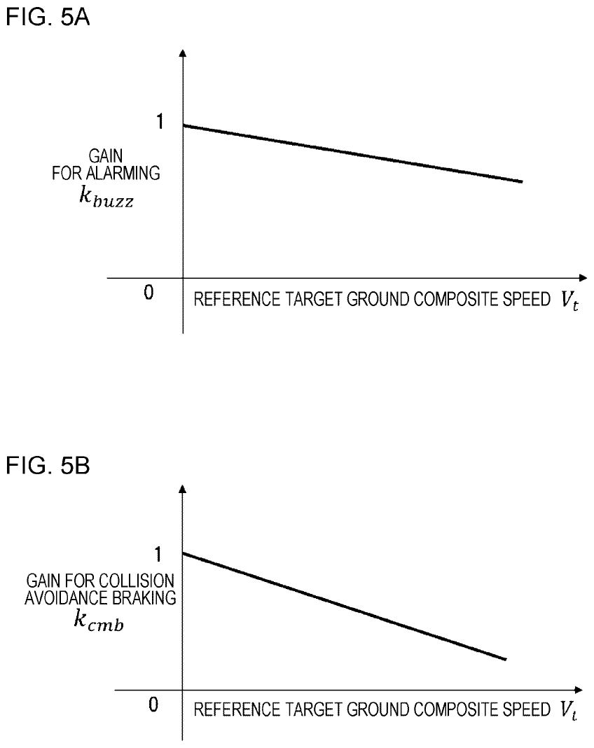

FIG. 4 shows a process flow of a program executed by the driving assistance function calculation unit 115.

First, at step S4_0, it is determined whether a reference target ground speed error calculated by the reference target ground speed error calculation unit 114 is an invalid value, and when the reference target ground speed error is not an invalid value, steps S4_1 and step S4_2 are executed.

At step S4_1, a correction gain k_{buzz} for alarming is acquired from the magnitude of the reference target ground speed error, using a correction map for alarming. It is reasonable that the correction map for alarming is created as a map in which the correction gain k_{buzz} for alarming gets smaller as the reference target ground speed error gets larger. This means that timing to execute alarm control for issuing an alarm to the driver of the vehicle 400, the alarm control being one of the driving assistance functions related to the safety of the vehicle, is delayed as the ground speed error of the reference target 404 gets larger.

Similarly, at step S4_2, a correction gain k_{cmb} for collision avoidance braking is acquired from the magnitude of the reference target ground speed error, using a correction map for collision avoidance braking. In the first embodiment, the correction gains k_{buzz} and k_{cmb} are each normalized value ranging from 0 to 1, and correction is made such that timing to activate the collision mitigation system is delayed as the correction gain gets smaller.

In other words, timing to execute automatic brake control of automatically applying a braking force to the vehicle 400, the automatic brake control being one of the driving assistance functions related to the safety of the vehicle, is delayed as the ground speed error of the reference target 404 gets larger.

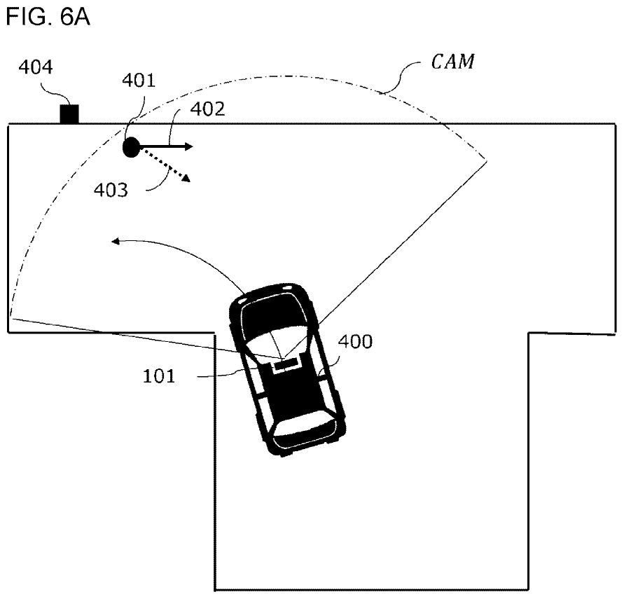

An example of the correction map of the gain for alarming is shown in FIG. 5A, and an example of the correction map of the gain for collision avoidance braking is shown in FIG. 5B. As shown in FIG. 5A, the gain k_{buzz} for alarming decreases as a reference target ground composite speed Vt increases. As shown in FIG. 5B, the gain k_{cmb} for collision avoidance braking decreases as the reference target ground composite speed Vt increases.

When it is determined at step S4_0 that the reference target ground speed error is an invalid value, the correction gains k_{buzz} and k_{cmb} are set to 1 at step S4_3 and step S4_4, respectively. This is a case where no reference target is detected and therefore the accuracy of a ground speed of a target as a control subject cannot be evaluated, thus indicating that correction of timing to activate the collision mitigation system is not carried out.

At step S4_5, the collision prediction unit 113 determines that there is a possibility of collision and determines whether a target posing the possibility of collision is a pedestrian. If the pedestrian posing the possibility of collision is not present, step S4_13 and step S4_14 are executed, in which case the collision mitigation system is not activated. It is assumed in the first embodiment that the target as the control subject is a pedestrian. However, the target as the control subject is not limited to a specific type of target and may be a bicycle, a car, or the like.

When the pedestrian posing the possibility of collision is present, with respect to an alarm intervention reference threshold Th_{buzz} [m] representing the distance between a host vehicle position indicating timing to start an alarm sound and a collision prediction point, a post-correction alarm intervention threshold Th_{nbuzz} [m] is calculated at step S4_6 by equation (5) below, using the correction gain k_{buzz} for alarming acquired at steps S4_1 or S4_3. The alarm intervention reference threshold Th_{buzz} [m] is obtained by an arbitrarily chosen method. For example, it may be obtained adjustably from a time TTC (Time To Collision) [sec] to elapse before the collision prediction point, a host vehicle speed, a lap rate at collision prediction, and the like.

$$\begin{matrix}[ Equation 5 ] & \\ {Th}_{nbuzz} = {k}_{buzz} \times {Th}_{buzz} & ( 5 )\end{matrix}$$

Subsequently, with respect to a collision avoidance brake intervention reference threshold Th_{cmb} [m] representing the distance between a host vehicle position indicating timing to start the collision avoidance brake and the collision prediction point, a post-correction collision avoidance brake intervention threshold Th_{ncmb} [m] is calculated at step S4_7 by equation (6) below, using the correction gain k_{cmb} for collision avoidance braking acquired at steps S4_2 or step S4_4.

The collision avoidance brake intervention reference threshold Th_{buzz} [m] is obtained by an arbitrarily chosen method. For example, it may be obtained adjustably from a TTC, a host vehicle speed, a lap rate at collision prediction, and the like.

$$\begin{matrix}[ Equation 6 ] & \\ {Th}_{ncmb} = {k}_{cmb} \times {Th}_{cmb} & ( 6 )\end{matrix}$$

At step S4_8, the distance that the host vehicle 400 travels from the current point to the point at which it collides with the pedestrian (which will hereinafter be referred to as “road distance” [m]) is calculated. The road distance is calculated by, for example, multiplying the host vehicle speed by TTC [sec].

Subsequently, at step S4_9, the road distance [m] calculated at step S4_8 is compared with the post-correction alarm intervention threshold [m] calculated at step S4_6. When the comparison reveals that the road distance [m] is longer than the post-correction alarm intervention threshold, it is determined that there is still sufficient time before the collision, and step S4_13 is executed, in which case the collision mitigation system is not activated.

When the road distance [m] is shorter than the post-correction alarm intervention threshold, it is determined that the collision with the pedestrian is imminent, and step S4_10 is executed to create a request instruction to sound an alarm.

After the request instruction to sound the alarm is created, an alarm activation request is transmitted to the output unit 116, which alarms the driver about a collision risk, using sound, light, vibration, and the like.

Subsequently, at step S4_11, the road distance [m] calculated at step S4_8 is compared with the post-correction collision avoidance brake intervention threshold [m] calculated at step S4_7. When the comparison reveals that the road distance [m] is longer than the post-correction collision avoidance brake intervention threshold [m], it is determined that the collision can be avoided by the driver's evasive action prompted by an alarm, and step S4_14 is executed, in which case the collision avoidance brake is not activated.

When the road distance [m] is shorter than the post-correction collision avoidance brake intervention threshold [m], it is determined that the collision with the pedestrian will definitely happen, and step S4_12 is executed to create a request instruction to activate the collision avoidance brake.

After the request instruction to activate the collision avoidance brake is created, the request instruction is transmitted to the output unit 116, which activates the automatic brake to avoid the collision with the pedestrian or reduce damage caused by the collision.

At step S4_13, the request instruction to sound the alarm is not transmitted to the output unit 116. Similarly, at step S4_14, the request instruction to activate the collision avoidance brake is not transmitted to the output unit 116.

FIGS. 6A and 6B depict examples of scenes for more specifically explaining processes of the first embodiment. For example, a case where the host vehicle 400 enters a T-shaped road and makes a left turn is assumed. It is a situation where the host vehicle 400 carries the camera 101 that captures an image of an area in front of the host vehicle 400 and the pedestrian 401 is visible in a detection range CAM of the camera 101 in FIG. 6A. A ground speed 403 (Vo_{b}jx, V_{obj} y) [m/sec] of the pedestrian 401 obtained by the target ground speed calculation unit 1104 is calculated.

To facilitate understanding of the present invention, an actual ground speed of the pedestrian 401 is denoted by reference numeral 402, which actual ground speed, however, cannot be directly observed. In FIG. 6A, the ground speed 403 detected by the camera 101 deviates from the ground speed 402 that is the true value, and this raises a possibility of making an erroneous determination that the host vehicle 400 will collide with the pedestrian 401.

FIG. 6B, on the other hand, shows a case where a stationary object 404 is too in the camera detection range CAM. In this case, when the stationary object 404 is treated as a reference target and this stationary object 404 develops a ground speed 405, the ground speed 405 can be regarded as an error in ground speed calculation by the camera 101, in which case it is considered that the ground speed 402 of the pedestrian 401 also develops a similar error.

In general, the collision mitigation system is activated when a road distance to a collision prediction point, at which collision with a target as a control subject occurs, becomes shorter than a certain threshold distance. Because of this fact, as a method of suppressing activation of the collision mitigation system, setting a small intervention value for alarming or collision avoidance braking is a reasonable method.

The ground speed calculation accuracy of the camera 101 is evaluated based on the magnitude of the reference target ground speed error, and when the reference target ground speed error is large, that is, when the ground speed calculation accuracy of the camera 101 is low, a small intervention threshold for alarming or collision avoidance braking is set according to the method described in the process flow of FIG. 4. By this process, unnecessary activation caused by an error in moving speed calculation can be prevented.

According to the first embodiment of the present invention, the vehicle control device that can suppress unnecessary activation of the collision mitigation system caused by a drop in the detection accuracy of target information when the host vehicle 400 is making a turn can be achieved.

The target position acquisition unit 1101 can acquire at least the position of the target recognized by the camera (external environment recognition unit) 101 incorporated in the vehicle 400.

The target ground speed calculation unit 1104 acquires at least the ground speed of the target recognized by the camera 101.

### Second Embodiment

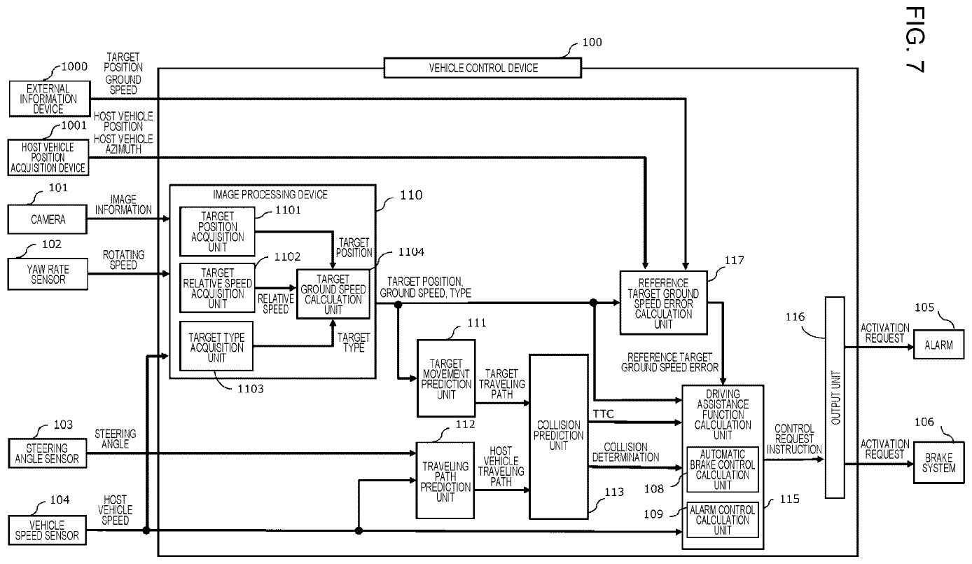

A second embodiment of the present invention will be described with reference to FIGS. 7 to 10.

In the first embodiment, a stationary object having zero ground speed is taken as an example of the reference target. In the second embodiment, however, a moving object having a ground speed of any given value, e.g., a pedestrian is included in reference targets.

FIG. 7 is a configuration explanatory diagram showing a configuration example of a vehicle control device 100 according to the second embodiment. In FIG. 7, a position and a ground speed of a moving object as a reference target are acquired from an external information device 1000. From the external information device 1000, the position and speed of the moving object are acquired through data communication, as data from, for example, a GPS device a pedestrian has, a surveillance camera installed in a city area, or the like.

A reference target ground speed error calculation unit 117, which acquires a position and an azimuth of the host vehicle from a host vehicle position acquisition device 1001 that is, for example, a GPS device incorporated in the host vehicle, checks a moving object acquired from the external information device 1000 against a target among targets being detected by the image processing unit 110 to determine whether the moving object and the target are the same object, using the host vehicle position and host vehicle azimuth acquired from the host vehicle position acquisition device 1001. With respect to the target determined to be the same object as the moving object, a deviation between a ground speed obtained from the external information device 1000 and a ground speed calculated by the image processing unit 110 is evaluated. In this manner, the accuracy of a ground speed of each target being detected by the image processing unit is evaluated.

Coordinate axes that define the position and direction of information obtained from the external information device 1000 and the host vehicle position acquisition device 1001 may be set arbitrarily. Nevertheless, the coordinate axes offer information that can be mapped onto the same system of coordinate axes, such as latitude and longitude given by the GPS.

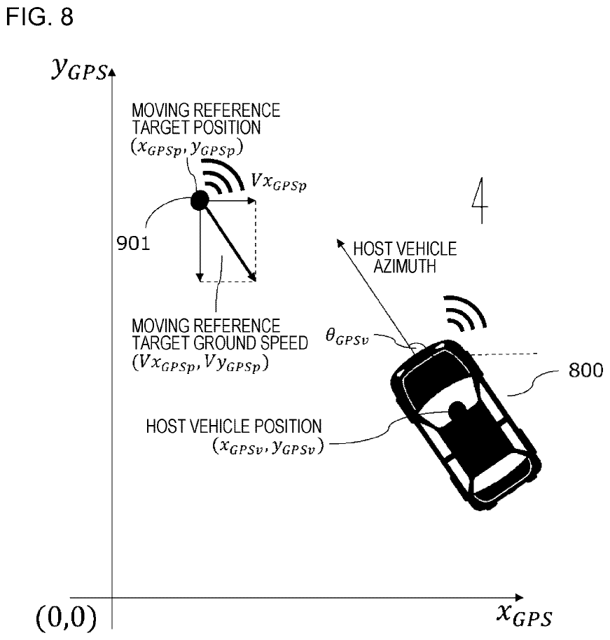

In this case, as shown in FIG. 8, with respect to an arbitrarily set reference point, an east direction is defined as a GPSX axis, a north direction is defined as a GPSY axis, an azimuth in the direction of the GPSX axis is defined as 0 degrees, an azimuth in direction of the GPSY axis is defined as 90 degrees, a position of the host vehicle 800 is defined as (x_{GPSv}, y_{GPSv}), an azimuth of the host vehicle is defined as θ_{GPSv}, a position of a moving reference target 901 is defined as (x_{GPSp}, y_{GPSp}), and a moving reference target ground speed is defined as (Vx_{GPSp}, Vy_{GPSp}). Hereinafter, this coordinate system is referred to as a GPS coordinate system.

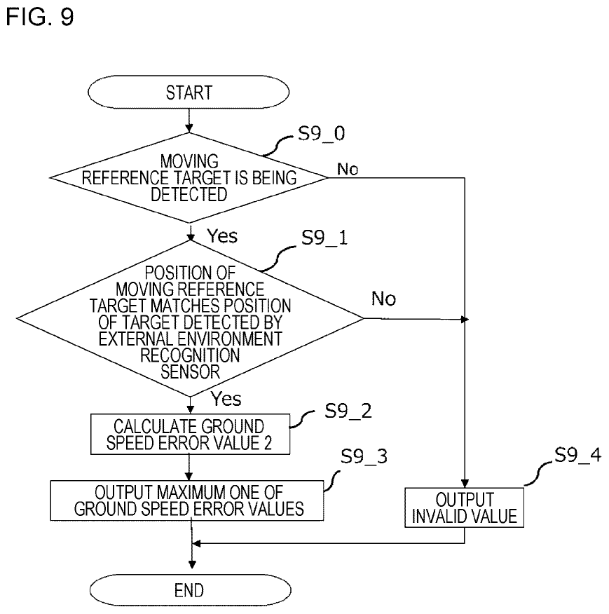

FIG. 9 depicts a process flow of the reference target ground speed error calculation unit 117 of FIG. 7. When a target obtained from the external information device 1000 is present and detected at step S9_0 of FIG. 9, whether the same object as the target is being detected by the external environment recognition sensor is determined at step S9_1. This determination is made in such a way that, for example, position information (x_{GPSp}, y_{GPSp}) on the target in the GPS coordinate system is mapped onto the vehicle coordinate system to generate (x′_{GPSp}, y′_{GPSp}), using equation (7) below, and when (x′_{GPSp}, y′_{GPSp}) and a target position (x_{obj}, y_{obj}) being detected by the external environment recognition sensor are sufficiently close to each other, it is determined that the same object is being detected by the external environment recognition sensor.

$$\begin{matrix}[ Equation 7 ] & \\ ( \begin{matrix}{x}_{GPSp}^{′} \\ {y}_{GPSp}^{′}\end{matrix} ) = ( \begin{matrix}cos ( - {θ}_{GPSv} ) & - sin ( - {θ}_{GPSv} ) \\ sin ( - {θ}_{GPSv} ) & cos ( - {θ}_{GPSv} )\end{matrix} ) ( \begin{matrix}{x}_{GPSp} - {x}_{GPSv} \\ {y}_{GPSp} - {y}_{GPSv}\end{matrix} ) & ( 7 )\end{matrix}$$

At step S9_1, the same target identified as a result of the determination that the target obtained from the external information device 1000 and the target obtained by the external environment recognition sensor are the same is treated as a reference target, and at step S9_2, a ground speed of the target obtained from the external information device 1000 is mapped onto the vehicle coordinate system, using equation (8) below, and a reference target ground speed error 2V_{obj2} [m/sec] is calculated, using equation (9) below.

$$\begin{matrix}[ Equation 8 ] & \\ ( \begin{matrix}{Vx}_{GPSp}^{′} \\ {Vy}_{GPSp}^{′}\end{matrix} ) = \sqrt{{Vx}_{GSPp}^{2} + {Vy}_{GPSp}^{2}} ( \begin{matrix}cos ( {tan}^{- 1} ( \frac{{Vy}_{GPSp}}{{Vx}_{GPSp}} ) - {θ}_{GPSv} ) \\ sin ( {tan}^{- 1} ( \frac{{Vy}_{GPSp}}{{Vx}_{GPSp}} ) - {θ}_{GPSv} )\end{matrix} ) & ( 8 )\end{matrix}$$

$$\begin{matrix}[ Equation 9 ] & \\ {V}_{obj 2} = \sqrt{{( {V}_{objx} - {Vx}_{GPSp}^{′} )}^{2} + {( {V}_{objy} - {Vy}_{GPSp}^{′} )}^{2}} & ( 9 )\end{matrix}$$

At step S9_3, when a plurality of reference targets are being detected simultaneously, the maximum one of reference target ground speed errors 2 V_{obj2} [m/sec] is selected and is outputted as a reference target ground speed error, to the driving assistance function calculation unit 115. If no reference target is detected, the reference target ground speed error is outputted as an invalid value at step S9_4.

After the reference target ground speed error calculation unit 117 obtains the reference target ground speed error, the driving assistance function calculation unit 115 and other units execute the same processes as described in the first embodiment.

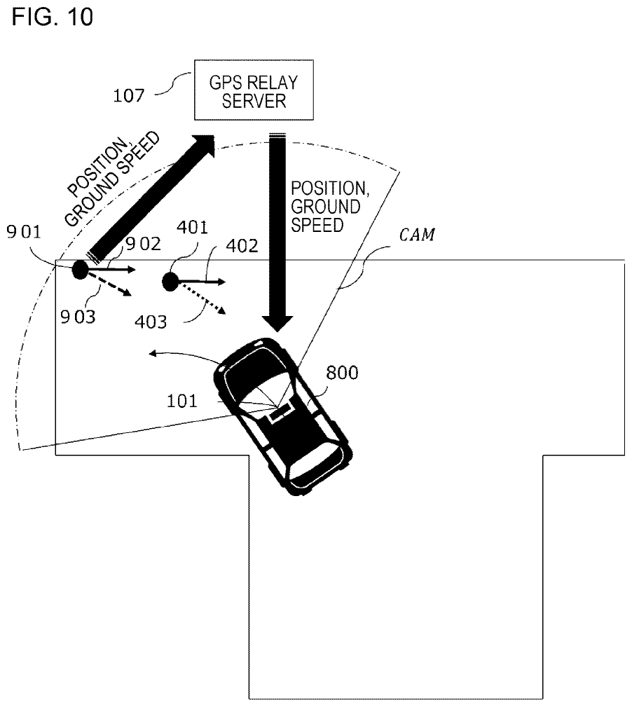

FIG. 10 is a bird's-eye view of an example of a scene for explaining the second embodiment, the scene being the same assumed case of the first embodiment where the host vehicle 800 enters a T-shaped road to make a left turn. In a case where the external environment recognition sensor incorporated in the host vehicle 800 detects the moving reference target 901 when the host vehicle 800 obtains position/speed information on the reference target 901 via a GPS relay server 107, a ground speed calculated by the external environment recognition sensor is indicated by a broken line arrow 903, whereas a ground speed received via the GPS relay server 107 is indicated by a solid line arrow 902. When a deviation has developed between both the ground speeds, it is considered that a ground speed indicated by an arrow 403 of a control subject object 401, the ground speed being calculated by the external environment recognition sensor, includes an error, too. In this case, by delaying timing to activate the collision mitigation system with respect to the control subject object 401, unnecessary activation caused by a ground speed error can be suppressed.

The second embodiment of the present invention offers the same effects as the first embodiment offers, and achieves the vehicle control device that can include a moving object having a ground speed of an arbitrary value in control subjects, as a reference target.

### Third Embodiment

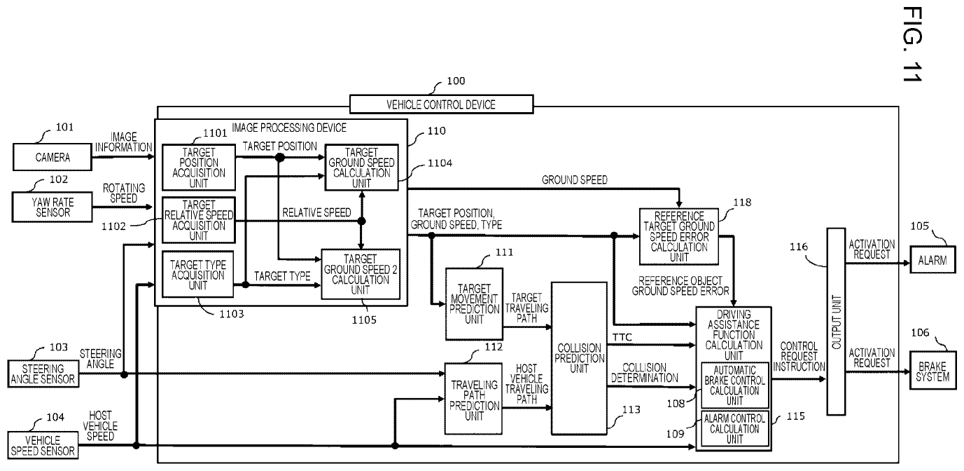

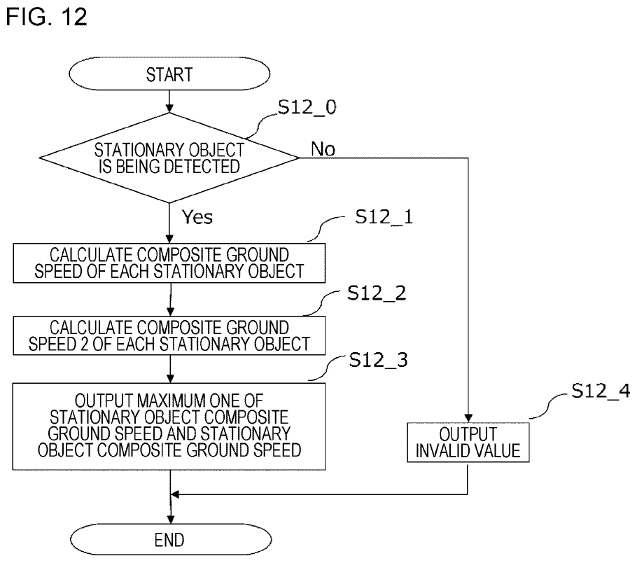

A third embodiment of the present invention will be described with reference to FIGS. 11 and 12.

FIG. 11 is a configuration explanatory diagram showing an example of a configuration of a vehicle control device 100 according to the third embodiment. In FIG. 11, in explanation of the third embodiment, a reference target is considered to be a stationary object in the same manner as in the first embodiment. However, the invention related to the moving object as described in the second embodiment may be combined with the invention of the third embodiment.

In addition to the configuration of the first embodiment shown in FIG. 1, the configuration of the third embodiment shown in FIG. 11 includes a target ground speed 2 calculation unit 1105 added to the image processing unit 110, the target ground speed 2 calculation unit 1105 calculating ground speed information on a stationary object not by the yaw rate sensor but by the steering angle sensor 103, and a reference target composite ground speed calculation unit 118 corrected in such a way as to calculate a reference target ground speed error, based on a target ground speed and on information on the target ground speed.

The target ground speed 2 calculation unit 1105 first obtains a steering angle conversion yaw rate γₜ [rad/sec], which is yaw rate information estimated from information outputted from the steering angle sensor 103. The steering angle conversion yaw rate γₜ [rad/sec] can be calculated by any given method, and may be calculated by, for example, equation (10) below.

$$\begin{matrix}[ Equation 10 ] & \\ {γ}_{t} = \frac{V}{ρ} = \frac{V}{( 1 - \frac{m}{2 {l}^{2}} \frac{{l}_{f} {K}_{f} - {l}_{r} {K}_{r}}{{K}_{f} {K}_{1}} {V}^{2} ) \frac{nl}{δ}} & ( 10 )\end{matrix}$$

In Equation (10), γₜ denotes a steering angle conversion yaw rate [rad/s], V denotes a host vehicle speed [m/s], ρ denotes a turning radius [m], m denotes a vehicle weight [kg], l denotes a wheel base, l_{f} denotes the vehicle's center of gravity and a front axle length [m], lᵣ denotes the vehicle's center of gravity and a rear axle length [m], δ denotes a steering angle sensor value [rad], K_{f} denotes front wheel cornering power [N/rad], Kr denotes rear wheel cornering power [N/rad], and n denotes a steering gear ratio.

A target ground speed (V_{objx2}, V_{objy2}) [m/sec] based on the steering angle sensor 103 is given by equation (11) below, which is obtained by substituting the steering angle conversion yaw rate γₜ [rad/sec] in ωₜ[rad/sec] in equation (3).

$$\begin{matrix}[ Equation 11 ] & \\ ( {V}_{objx 2} , {V}_{objy 2} ) = ( \frac{{x}_{obj} - {x}_{obj\_z}}{Δ t} + {V}_{sx} - {y}_{obj} {γ}_{t} , \frac{{x}_{obj} - {x}_{obj\_z}}{Δ t} + {V}_{sy} - {y}_{obj} {γ}_{t} ) & ( 11 )\end{matrix}$$

A process flow executed at the reference target ground speed error calculation unit 118 is shown in FIG. 12.

In FIG. 12, whether a stationary object as a reference target is being detected is determined at step S12_0 in the same manner as at a step in the process flow of FIG. 2. When no stationary object is detected, an invalid value is outputted at step S12_4. When a stationary object is being detected at step S12_0, a composite ground speed of each stationary object is calculated at step S12_1. The method of the calculation is the same as the method expressed by equation (1). Subsequently, at step S12_2, a composite ground speed of each stationary object is calculated. The method of the calculation is, for example, given by equation (12) below.

$$\begin{matrix}[ Equation 12 ] & \\ {V}_{obj 2} = \sqrt{{V}_{objx 2}^{2} + {V}_{objy 2}^{2}} & ( 12 )\end{matrix}$$

Subsequently, for each stationary object, the maximum one of the stationary object composite ground speed and the stationary object composite ground speed 2 is selected at step S12_3, and is outputted as a reference object ground speed error. In other words, the composite ground speed representing the maximum ground speed error is selected and outputted.

In the third embodiment, a steering angle sensor value does not directly affect the accuracy of the target ground speed but affects the accuracy of traveling path prediction. That is, when the steering angle sensor 103 develops an error, it results in a drop in the accuracy of traveling path prediction, raising a concern that unnecessary activation of collision avoidance control may occur. It is therefore necessary that evaluation of the accuracy of the steering angle sensor 103 be carried out also. In general, accuracy compensation of the yaw rate sensor 102 and accuracy compensation of the steering angle sensor 103 are separately provided. However, by applying the third embodiment, an error in the value of the yaw rate sensor 102 and an error in the value of the steering angle sensor 103 can be uniformly evaluated under the main goal of suppressing unnecessary activation of the collision mitigation system.

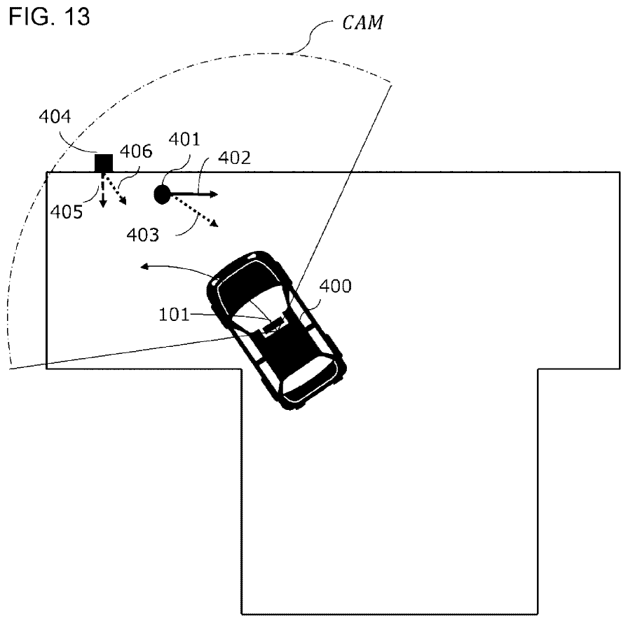

FIG. 13 is a bird's-eye view of an example of a scene for explaining the third embodiment, the scene being the same assumed case of the first embodiment where the host vehicle 400 enters a T-shaped road to make a left turn. In the first embodiment, when a stationary object and a pedestrian simultaneously enter the detection range of the camera, a result given by calculating the ground speed of the stationary object, using a yaw rate sensor value, is used. In the third embodiment, on the other hand, a target ground speed based on a steering angle conversion yaw rate value calculated from the steering angle sensor 103 is used also. A ground speed 405 of a stationary object is obtained by using a detection value from the yaw rate sensor 102, and a ground speed 406 of the stationary object is obtained by using a detection value from the steering angle sensor 103. One of these ground speeds that is larger as a composite speed is transmitted as a reference object ground speed error, to the driving assistance function calculation unit 115. The process the driving assistance function calculation unit 115 carries out is the same as the process shown in FIG. 3.

By redundantly evaluating the ground speed of the stationary object, using values from sensors different in rotating speed, unnecessary activation of collision avoidance control can be suppressed more firmly as error components included in the yaw rate sensor 102 and in the steering angle sensor 103 are integrally evaluated.

The third embodiment of the present invention offers the same effects as the first embodiment offers. In addition, as described above, the vehicle control device includes the plurality of means (1104, 1105) that calculate the target ground speed, and is configured to redundantly evaluate the ground speed error of the target. Hence the vehicle control device that can suppress unnecessary activation of collision avoidance control more firmly can be achieved.

### Fourth Embodiment

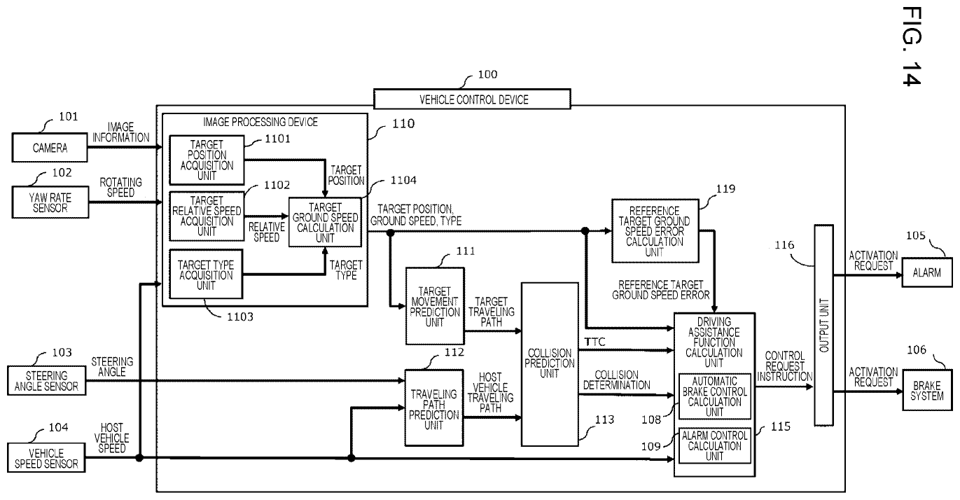

A fourth embodiment of the present invention will be described with reference to FIGS. 14 to 16.

FIG. 14 is a configuration explanatory diagram showing an example of a configuration of a vehicle control device 100 according to the fourth embodiment. In explanation of the fourth embodiment, a reference target is considered to be a stationary object in the same manner as in the first embodiment. However, the fourth embodiment may be combined with the second embodiment or the third embodiment.

In FIG. 14, the reference target ground speed error calculation unit 114 in the configuration diagram of the first embodiment shown in FIG. 1 is replaced with a reference target ground speed error calculation unit 119. The reference target ground speed error calculation unit 119 detects a stationary object and calculates a ground composite speed of the stationary object. After this, when the ground composite speed of the stationary object is so large as to exceed a given value, the driving assistance function calculation unit 115 regards it as an error in selecting a reference target, e.g., erroneously selecting a moving sign as a reference target, and excludes the ground composite speed of the stationary object from the subject of calculation of a reference target ground speed error, and therefore decides not to adjust timing to execute automatic brake control. In addition, the driving assistance function calculation unit 115 decides not to adjust timing to execute alarm control as well.

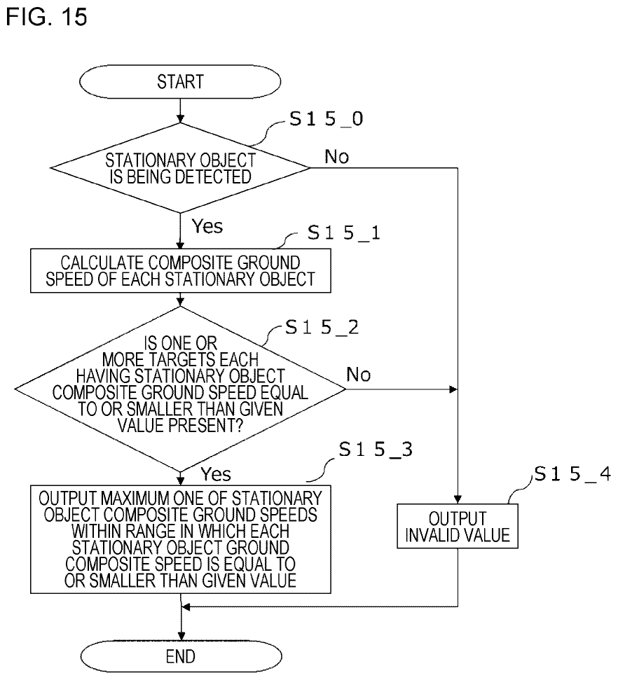

FIG. 15 is a flowchart showing a process flow of the reference target ground speed error calculation unit 119 according to the fourth embodiment.

In FIG. 15, it is determined at step S15_0 that at least one or more stationary objects are being detected among detection targets. When the stationary object is being detected, with respect to ground speed information on the stationary object outputted from the image processing unit 110, a composite speed V_{obj} [m/sec] is calculated at step S15_1 by equation (4) shown above, using the ground speed (V_{objx}, V_{objy}) [m/sec] of the stationary object.

With respect to the fact that the true value of the composite speed V_{obj} [m/sec] is zero, whether the composite speed V_{obj} [m/sec] is within a range in which the composite speed V_{obj} [m/sec] may develop as a ground speed error is determined at step S15_2. In a case where at least one or more stationary objects each having the composite speed V_{obj} [m/sec] within the range in which the composite speed V_{obj} [m/sec] may develop as a ground speed error are present, at step S15_3, a stationary object having a ground speed exceeding the range in which the ground speed may develop as a ground speed error is ignored, and the maximum one of composite speeds V_{obj} [m/sec] of stationary objects within the range in which the composite speed V_{obj} [m/sec] may develop as a ground speed error is selected and is outputted as a reference target ground speed error.

When no stationary object is detected at step S15_0, an invalid value is outputted as the reference target ground speed error at step S15_4.

Even if a stationary object is detected, when ground speeds of all stationary objects exceed the range in which the ground speed may develop as a ground speed error at step S15_2, the stationary object detected is not suitable as a reference target. The stationary object is thus considered to be, for example, a moving sign, in which case an invalid value is outputted.

After the reference target ground speed error calculation unit 119 obtains the reference target ground speed error, the processes the driving assistance function calculation unit 115 and other units execute are the same processes as described in the first embodiment.

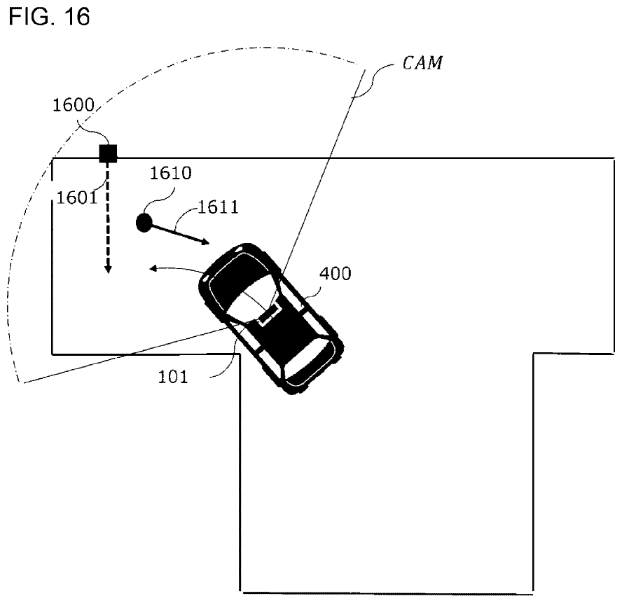

FIG. 16 is a bird's-eye view of an example of a scene for explaining the fourth embodiment, the scene being the same assumed case of the first embodiment where the host vehicle 400 enters a T-shaped road to make a left turn. The fourth embodiment is a scene where a target 1600 is determined to be a stationary object from the shape of a detection object detected in the CAM, which is the detection range of the camera 101, and at the same time, a ground speed 1611 of a moving object 1610 detected in the CAM is calculated. It is determined in this scene that the host vehicle 400 is going to collide with the target 1610.

At this time, when a ground speed 1601 of the target 1600 is calculated at a sufficiently large value, the target 1600 is treated as a moving object not suitable as a reference object, despite the fact that it has been temporarily determined to be a stationary object because of its shape, and correction, such as delaying timing to activate the collision mitigation system with respect to the target 1610, based on the magnitude of the ground speed 1601, is not executed.

Thus, the collision mitigation system can be activated at proper timing with respect to the target 1610 without excessively suppressing its activation in an erroneous manner.

The fourth embodiment of the present invention offers the same effects as the first embodiment offers. In addition to this, because of the above-described configuration in which after a stationary object is detected and a ground composite speed of the stationary object is calculated, when the ground composite speed of the stationary object is a value so large as to exceed a given value, the stationary object is treated as a moving object and is excluded from the subject of calculation of a reference target ground speed error, the fourth embodiment also offers the effect that the collision mitigation system can be activated at proper timing without excessively suppressing its activation in an erroneous manner.

### REFERENCE SIGNS LIST

100 vehicle control device
101 camera (external environment recognition unit)
102 yaw rate sensor (rotation angle acquisition unit)
103 steering angle sensor
104 vehicle speed sensor (vehicle speed acquisition unit)
105 alarm (driving assistance function execution unit)
106 brake system (driving assistance function execution unit)
107 GPS relay server
108 automatic brake control calculation unit
109 alarm control calculation unit
110 image processing unit
111 target movement prediction unit
112 traveling path prediction unit
113 collision prediction unit
114, 117, 118, 119 reference target ground speed error calculation unit
115 driving assistance function calculation unit
301 target
400, 800 host Vehicle
401 pedestrian
404 stationary object (reference target)
901 moving reference target
1000 external information device
1001 host vehicle position acquisition device
1101 target position acquisition unit
1102 target relative speed acquisition unit
1103 target type acquisition unit
1104 target ground speed calculation unit
1105 target ground speed 2 calculation unit
1600 target
1610 moving object

1. A vehicle control device comprising:
a rotating speed acquisition unit that acquires a rotating speed of a vehicle;
a vehicle speed acquisition unit that acquires a speed of the vehicle; a target position acquisition unit that acquires a position of a target recognized by an external environment recognition unit incorporated in the vehicle;
a target ground speed calculation unit that acquires a ground speed of the target recognized by the external environment recognition unit;
a reference target ground speed error calculation unit that acquires a ground speed error of a reference target serving as a reference outside the vehicle;
a driving assistance function calculation unit that obtains execution content of a driving assistance function related to safety of the vehicle against a moving object recognized by the external environment recognition unit, using the ground speed error of the reference target; and
an output unit that outputs a control instruction for executing the driving assistance function, to a driving assistance function execution unit of the vehicle, based on the execution content obtained by the driving assistance function calculation unit.

2. The vehicle control device according to claim 1, wherein the reference target is a stationary object.

3. The vehicle control device according to claim 1, comprising:
an external information device that acquires a ground speed of the reference target; and
a host vehicle position acquisition device that acquires a position of the vehicle,
wherein the reference target ground speed error calculation unit acquires a ground speed error of the reference target, based on the ground speed of the reference target, the ground speed being acquired by the external information device, and on the position of the vehicle.

4. The vehicle control device according to claim 2, wherein
a driving assistance function calculation unit includes an automatic brake control calculation unit that, with respect to the target recognized by the external environment recognition unit, obtains execution content of automatic brake control that automatically applies a braking force to the vehicle, the automatic brake control being one of driving assistance functions related to safety of the vehicle, based on a ground speed error of the reference target, and
the output unit outputs a control instruction for executing the automatic brake control to a brake system of the vehicle, based on a result from the automatic brake control calculation unit.

5. The vehicle control device according to claim 4, wherein timing to execute the automatic brake control that automatically applies a braking force to the vehicle, the automatic brake control being one of driving assistance functions related to safety of the vehicle, is delayed as a ground speed error of the reference target gets larger.

6. The vehicle control device according to claim 5, wherein in a case where a ground speed error of the reference target is a value so large as to exceed a given value, the driving assistance function calculation unit regards the case as an error in selecting the reference target, and does not adjust timing to execute the automatic brake control.

7. The vehicle control device according to claim 2, wherein
the driving assistance function calculation unit includes an alarm control calculation unit that with respect to the moving object recognized by the external environment recognition unit, obtains execution content of alarm control for issuing an alarm to a driver of the vehicle, the alarm control being one of driving assistance functions related to safety of the vehicle, based on a ground speed error of the reference target, and
the output unit outputs a control instruction for executing the alarm control to an alarm of the vehicle, based on a result from the alarm control calculation unit.

8. The vehicle control device according to claim 7, wherein timing to execute alarm control for issuing an alarm to a driver of the vehicle, the alarm control being one of driving assistance functions related to safety of the vehicle, is delayed as a ground speed error of the reference target gets larger.

9. The vehicle control device according to claim 8, wherein in a case where a ground speed error of the reference target is a value so large as to exceed a given value, the driving assistance function calculation unit regards the case as an error in selecting the reference target, and does not adjust timing to execute the alarm control.

10. The vehicle control device according to claim 1, comprising a plurality of the target ground speed calculation units, wherein the ground speed error is evaluated redundantly.

11. The vehicle control device according to claim 10, wherein with respect to the ground speeds calculated by a plurality of the target ground speed calculation units, a ground speed representing a maximum ground speed error is selected as the ground speed error of the reference target.
